(19) United States
(12) Patent Application Publication
(10) Pub. No.: US 2017/0154362 A1
(43) Pub. Date: Jun. 1, 2017

(54) SYSTEM AND METHOD FOR SUPPORTING SALE

(71) Applicant: OPTiM Corporation, Saga (JP)

(72) Inventor: Shunji SUGAYA, Tokyo (JP)

(21) Appl. No.: 15/151,594

(22) Filed: May 11, 2016

(30) Foreign Application Priority Data
Nov. 26, 2015 (JP) 2015-231150

(51) Int. Cl. G06Q 30/02

(52) U.S. Cl. CPC G06Q 30/0269

(57) ABSTRACT

The present invention is to provide a system for supporting sale that improves purchaser's satisfaction and requires a seller not to pay ad rates. The system for supporting sale of an article includes an evaluation module 111 that evaluates a seller of the article, a point addition module 212 that adds a point based on the evaluation, and an advertisement display module 112 that displays an advertisement of the article on a purchaser's terminal by consuming the point.

### CROSS REFERENCE TO RELATED APPLICATIONS

This application claims priority to Japanese Patent Application No. 2015-231150 filed on Nov. 26, 2015, the entire contents of which are incorporated by reference herein.

Technical Field

The present invention relates to a system and a method for supporting sale to display an advertisement based on an evaluation point.

Background Art

Recently, the method of reducing the cost burden of advertising offline has been widespread, in which sellers post the advertisements of articles for sale through a communication network such as the Internet (Refer to Patent Document 1).

When posting an advertisement on a (worldwide) web page on such the Internet, sellers usually pay ad rates to the manager of the web page or the operator of the sale system on which the sellers wish to place the advertisement. Then, the manger or the operator displays the advertisement based on the amount of the payment.

### CITATION LIST

### Patent Literature

Patent Document 1: JP 2002-342436 A

### SUMMARY OF INVENTION

However, in order to improve the customer satisfaction of users as purchasers, the sale system is required to lead the users to purchase more articles with high user evaluation.

Moreover, the method of more effectively posting advertisements of articles for sale without paying ad rates has been desired to be provided for sellers of articles.

In view of the above-mentioned problems, an objective of the present invention relates to a system and a method for supporting sale to display an advertisement based on an evaluation point.

The first aspect of the present invention provides a system for supporting sale of an article, including;
an evaluation unit that evaluates a seller of the article;
a point addition unit that adds a point based on the evaluation; and
an advertisement display unit that displays an advertisement of the article on a purchaser's terminal by consuming the point.

According to the first aspect of the present invention, a system for supporting sale of an article includes;
an evaluation unit that evaluates a seller of the article;
a point addition unit that adds a point based on the evaluation; and
an advertisement display unit that displays an advertisement of the article on a purchaser's terminal by consuming the point.

The first aspect of the present invention falls into the category of a system for supporting sale, but the categories of a method for supporting sale have similar functions and effects.

The second aspect of the present invention provides the system according to the first aspect of the present invention, in which the evaluation unit receives an evaluation from the purchaser's terminal, the user of which purchases the article.

According to the second aspect of the present invention, in the system according to the first aspect of the present invention, the evaluation unit receives an evaluation from the purchaser's terminal, the user of which purchases the article.

The third aspect of the present invention provides the system according to the first aspect of the present invention, in which the evaluation unit receives an evaluation from a terminal for supporting sale of the system.

According to the third aspect of the present invention, in the system according to the first aspect of the present invention, the evaluation unit receives an evaluation from a terminal for supporting sale of the system.

The fourth aspect of the present invention provides the system according to the first aspect of the present invention, further including a selection unit that selects a display size of an advertisement of the article based on the consumed point.

According to the fourth aspect of the present invention, the system according to the first aspect of the present invention, further includes a selection unit that selects a display size of an advertisement of the article based on the consumed point.

The fifth aspect of the present invention provides the system according to the first aspect of the present invention, further including a selection unit that selects a display location of an advertisement of the article based on the consumed point.

According to the fifth aspect of the present invention, the system according to the first aspect of the present invention further includes a selection unit that selects a display location of an advertisement of the article based on the consumed point.

The sixth aspect of the present invention provides the system according to the first aspect of the present invention, further including a selection unit that selects a type of an advertisement of the article based on the consumed point.

According to the sixth aspect of the present invention, the system according to the first aspect of the present invention further includes a selection unit that selects a type of an advertisement of the article based on the consumed point.

The seventh aspect of the present invention provides the system according to the first aspect of the present invention, further including a transmission unit that transmits data to select any one of a display size, a display location, and a type of an advertisement of the article based on the consumed point to a purchaser's terminal.

According to the seventh aspect of the present invention, the system according to the first aspect of the present invention further includes a transmission unit that transmits data to select any one of a display size, a display location, and a type of an advertisement of the article based on the consumed point to a purchaser's terminal.

According to the eighth aspect of the present invention, a method executed by a system for supporting sale of an article includes the steps of:
evaluating a seller of the article;
adding a point based on the evaluation; and
displaying the advertisement of the article on a purchaser's terminal by consuming the point.

The present invention is to provide a system and a method for supporting sale to display an advertisement based on an evaluation point.

### BRIEF DESCRIPTION OF DRAWINGS

FIG. 1 shows a schematic diagram of a preferable embodiment of the present invention.

FIG. 2 shows a functional block diagram of the purchaser's terminal 100, the server 200, and the seller's terminal 300 to illustrate the relationship among the functions.

FIG. 3 shows a flow chart of the point addition and the advertisement display performed by the purchaser's terminal 100, the server 200, and the seller's terminal 300.

FIG. 4 shows a flow chart of the point addition by the server 200 based on the evaluation by the purchaser's terminal 100.

FIG. 5 shows a functional block diagram of the purchaser's terminal 100, the server 200, the seller's terminal 300, and the terminal for supporting sale 400 to illustrate the relationship among the functions.

FIG. 6 shows a flow chart of the point addition and the advertisement display performed by the purchaser's terminal 100, the server 200, the seller's terminal 300, and the terminal for supporting sale 400.

FIG. 7 shows one example of the article information transmitted from the seller's terminal 300 to the server 200.

FIG. 8 shows one example of the article sales page displayed on the purchaser's terminal 100.

FIG. 9 shows one example of the article evaluation page displayed on the purchaser's terminal 100.

FIG. 10 shows one example of the data for each seller that include an evaluation from a purchaser and a point added based on the evaluation.

FIG. 11 shows one example of the data for each seller that include a point added based on the evaluation, a point added by a terminal for supporting sale, and a total point.

FIG. 12 shows one example of the advertisement display on the purchaser's terminal 100.

FIG. 13 shows one example of the screen to select the display size of an advertisement to be displayed on the seller's terminal 300.

FIG. 14 shows one example of the screen to select the display location of an advertisement to be displayed on the seller's terminal 300.

FIG. 15 shows one example of the screen to select the type of an advertisement to be displayed on the seller's terminal 300.

### DESCRIPTION OF EMBODIMENTS

Embodiments of the present invention will be described below with reference to the attached drawings. However, this is illustrative only, and the technological scope of the present invention is not limited thereto.

### Overview Of System For Supporting Sale

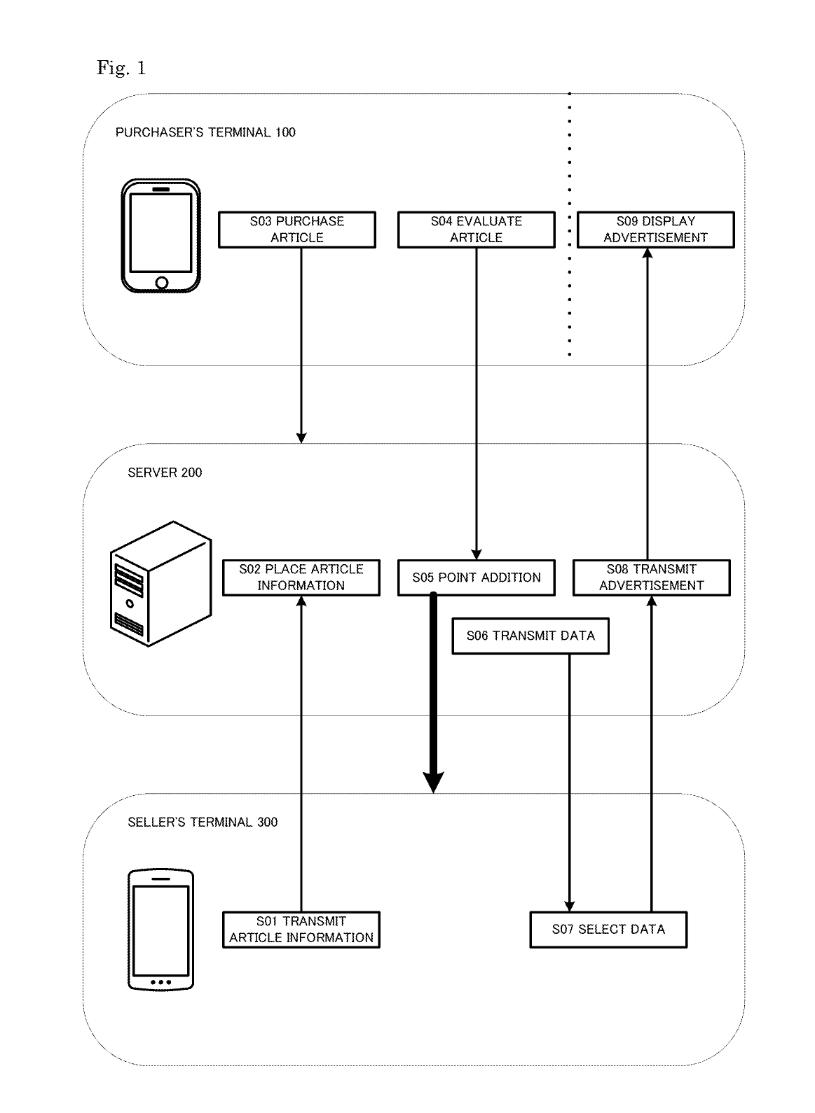

The overview of the present invention will be described below with reference to FIG. 1. The purchaser's terminal 100, the server 200, and the seller's terminal 300 are communicative among them through a communication network such as the Internet. The purchaser's terminal 100 and the seller's terminal 300 may communicate with the server 200 through a dedicated network, etc. There is no problem on the structure even if the purchaser's terminal 100 does not directly communicate with the seller's terminal 300.

When an article is sold, the seller's terminal 300 first transmits article information on an article to be sold to the server 200 (step S01). The article information includes the brand name, price, seller, stock quantity of an article to be sold, and the seller's ID.

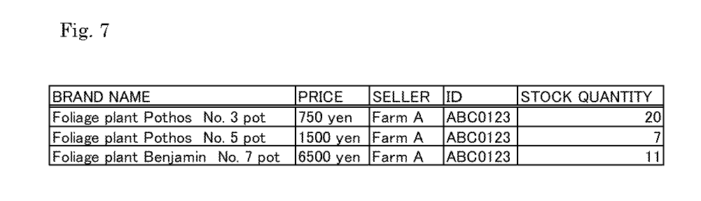

FIG. 7 shows one example of the article information transmitted from the seller's terminal 300 to the server 200. The article information includes a seller's ID in addition to a brand name, a price, and a stock quantity. Providing a unique ID to a seller, the system can recognizes the seller as the same seller even if the seller uses a plurality of seller's terminals such as a seller's terminal 300a, for example, a desktop personal computer and a seller's terminal 300b, for example, a smart phone. The image information, the details, etc., of an article may be transmitted together with the article information.

The server 200 receives the article information from the seller's terminal 300 and places article information (step S02). The article informational is placed on a website of the system for supporting sale, an online shopping site, etc., on a network, which a user can view on a purchaser's terminal 100.

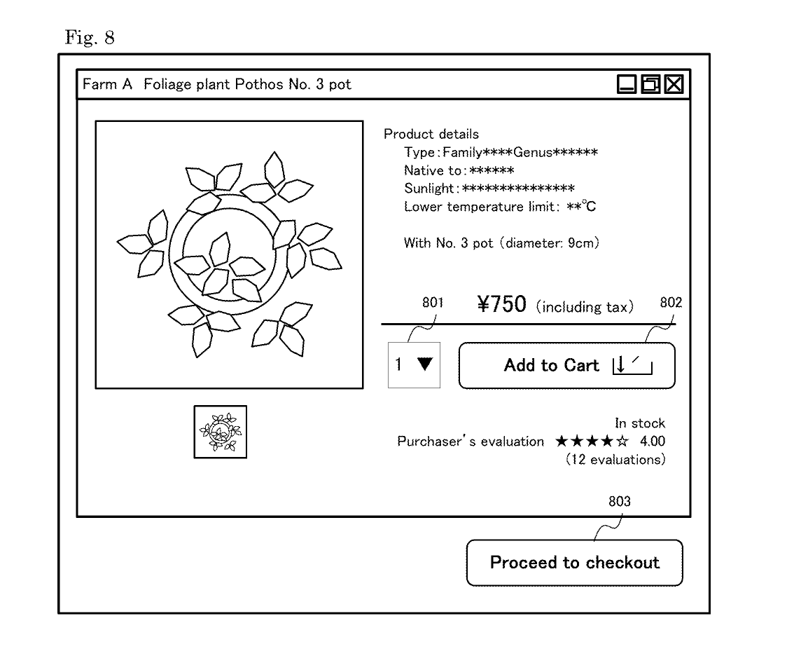

FIG. 8 shows one example of the article sales page displayed on the purchaser's terminal 100. Information necessary for a purchaser that includes the brand name, the price, and the seller of the sales article is displayed. The image information, the details, the stock status of an article, the evaluation of an article from other purchasers, etc., may also be displayed.

The user purchases an article from the purchaser's terminal 100 based on the displayed article information (step S03). For example, the user selects a purchase quantity from the combo box 801 and selects the add-to-cart button 802 with an article, on the article sales page shown in FIG. 8. Then, the user presses the proceed-to-checkout button 803 to perform necessary checkout procedure, for example, to input a delivery address, a payment option, etc. The article checkout procedure is not limited to the scope of the present invention. Any methods used in a typical online shopping can be applied.

After purchasing an article, the user evaluates the article purchased from the purchaser's terminal 100 (step S04). The evaluation represents the satisfaction of the purchased article or with the seller in a number. The number of evaluation item does not have to be one and may be two or more. When the number of the evaluation items is two or more, the respective numerical values, the average score, or the total point of all the evaluation items may be transmitted to the server 200.

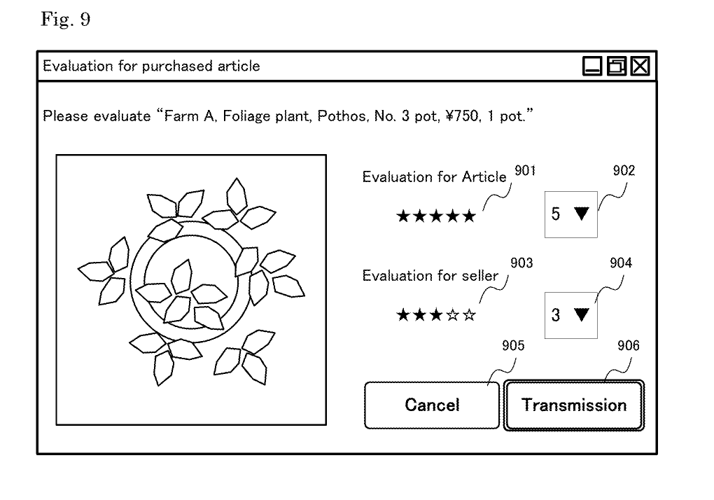

FIG. 9 shows one example of the article evaluation page displayed on the purchaser's terminal 100. When inputting the evaluation of an article, a purchaser can evaluate an article by selecting only the number of marks corresponding to the evaluation value in the evaluation graph 901 or by selecting a numerical value corresponding to the evaluation by the combo box 902. When inputting the evaluation of a seller, a purchaser selects only the number of marks corresponding to the evaluation value in the evaluation graph 903 or selects a numerical value corresponding to the evaluation by the combo box 904 in the same way. The example of FIG. 9 shows a screen to which a purchaser inputs only the numerical value of evaluation. However, the screen has a structure in which a purchaser can enter evaluation in text. The evaluation is transmitted to the server 200 by selecting the transmission button 906. The transmission of evaluation can be canceled by selecting the cancellation button 905.

In response to receiving the evaluation from the purchaser's terminal 100, the server 200 provides a point to the seller's ID (step S05).

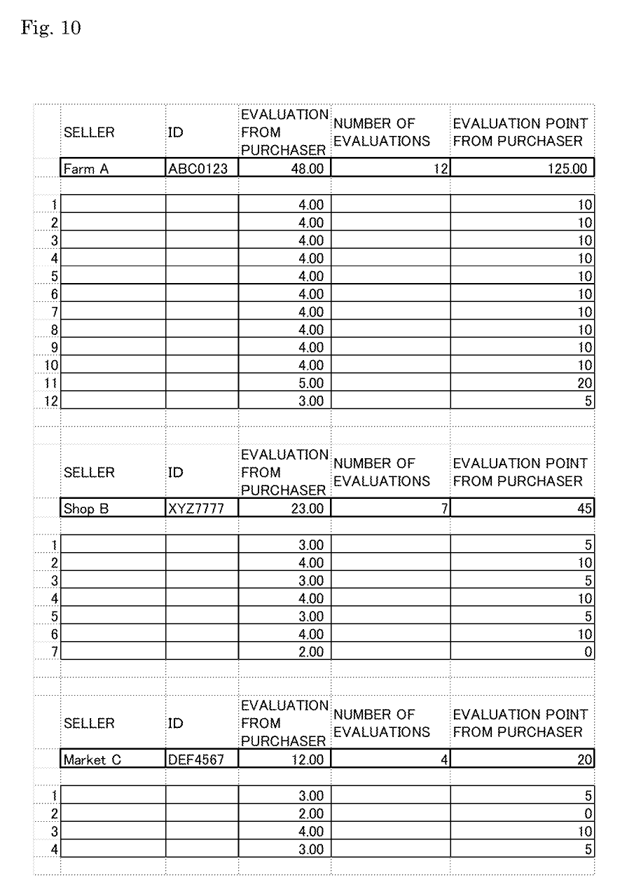

FIG. 10 is one example of the data for each seller that include an evaluation from a purchaser and a point added based on the evaluation. FIG. 10 shows the evaluations and the points of the farm A (ID: ABC0123), the shop B (ID: XYZ7777), and the market C (ID: DEF4567) in the upper, middle, and lower, respectively. In this example, if the evaluation is 5, 4, and 3, 20, 10, and 5 points are added, respectively. If the evaluation is less than 3, no points are added. As the result, the farm A, the shop B, and the market C earn 125, 45, and 20 points from 12, 7, and 4 evaluations, respectively. The number of points to be added based on each evaluation value can be arbitrarily set and appropriately changed in the system for supporting sale. Moreover, a minus point can be added if the evaluation value is low, for example.

The server 200 transmits data to place an advertisement on the system for supporting sale to the seller's terminal 300 (step S06). This data is information required to select the size, the location, the type, etc., of the advertisement that a seller wishes to place. The server 200 also transmits the earned points of a seller's ID.

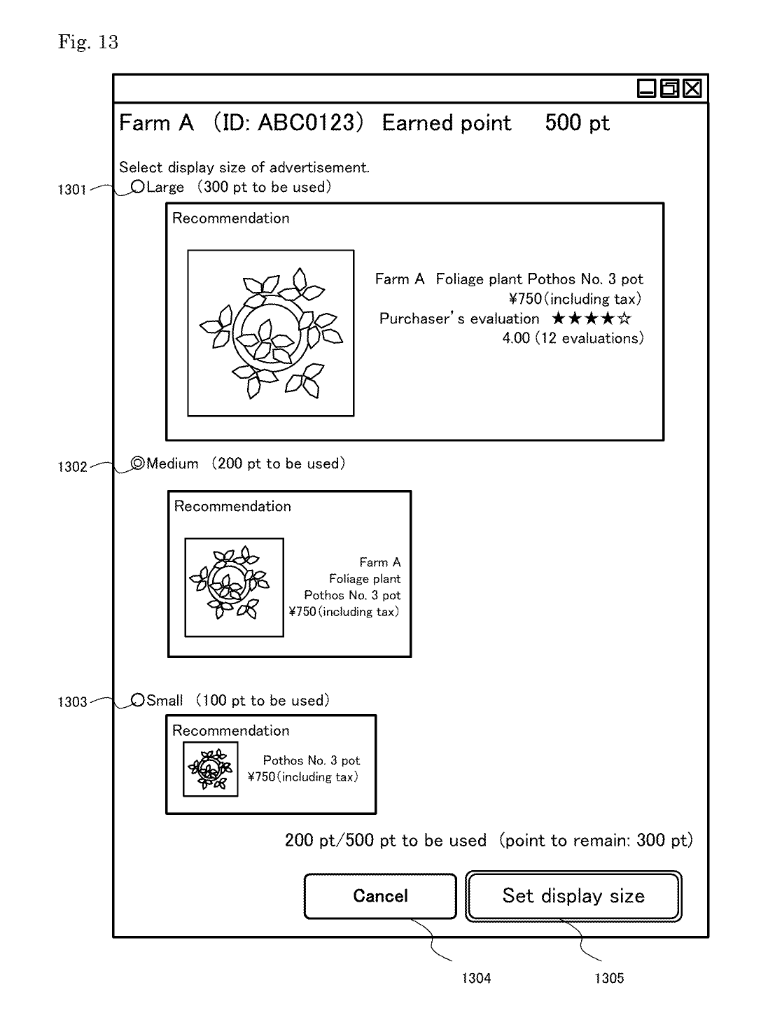

The seller's terminal 300 selects data to place an advertisement on the system for supporting sale based on the data received from the server 200 and transmits the selection result to the server 200 (step S07). FIGS. 13, 14, and 15 show one example of the screen to select the display size, the location, and the type of an advertisement to be displayed on the seller's terminal 300, respectively.

FIG. 13 shows one example of the screen to select the display size of an advertisement to be displayed on the seller's terminal 300. In this figure, the farm A whose ID is ABC0123 currently has 500 points, and the radio buttons 1301 to 1303 are provided to select the display size of an advertisement. The radio buttons 1301, 1302, and 1303 are user interfaces (hereinafter referred to as “UI”) to select a size of an advertisement from the large, medium, and small, which consumes 300, 200, and 100 points from the earned points, respectively. The radio buttons are to select only one from a plurality of choices. FIG. 13 shows that the radio button 1302 is selected. The seller sets the size of an advertisement to be displayed by pressing the set-display-size button 1305 after selecting the display size of an advertisement on this screen. If selecting the cancellation button 1304, a seller can cancel the selection of the display size of an advertisement. The remaining points may be displayed after the display size of an advertisement is set. In addition, if there is an option that cannot be selected because the present earned points are not enough, the option and its radio button may gray out or may not be displayed.

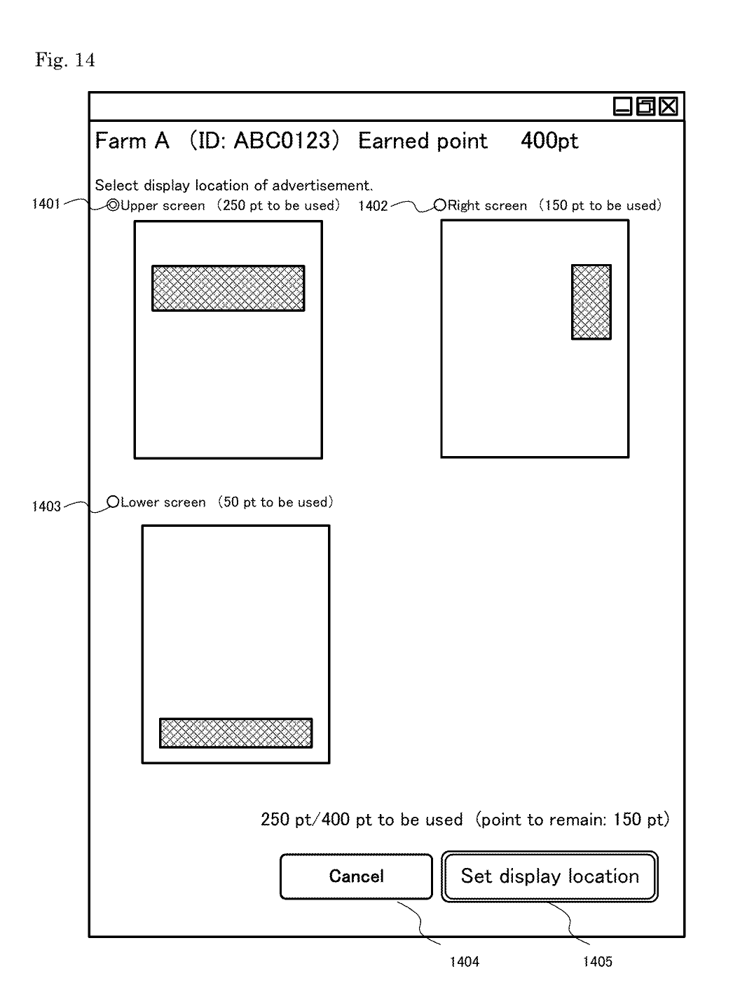

FIG. 14 shows one example of the screen to select the display location of an advertisement to be displayed on the seller's terminal 300. In this figure, the farm A whose ID is ABC0123 currently has 400 points, and the radio buttons 1401 to 1303 are provided to select the display location of an advertisement. The radio buttons 1401, 1402, and 1403 are user interfaces to select a location an advertisement from the upper, right, and lower, which consumes 250, 150, and 50 points from the earned points, respectively. FIG. 14 shows that the radio button 1401 is selected. The seller sets the display location of an advertisement to be displayed by pressing the set-display-location button 1405 after selecting the display location of an advertisement on this screen. If selecting the cancellation button 1404, a seller can cancel the selection of the display location of an advertisement. The remaining points may be displayed after the display location of an advertisement is set. In addition, if there is an option that cannot be selected because the present earned points are not enough, the option and its radio button may gray out or may not be displayed.

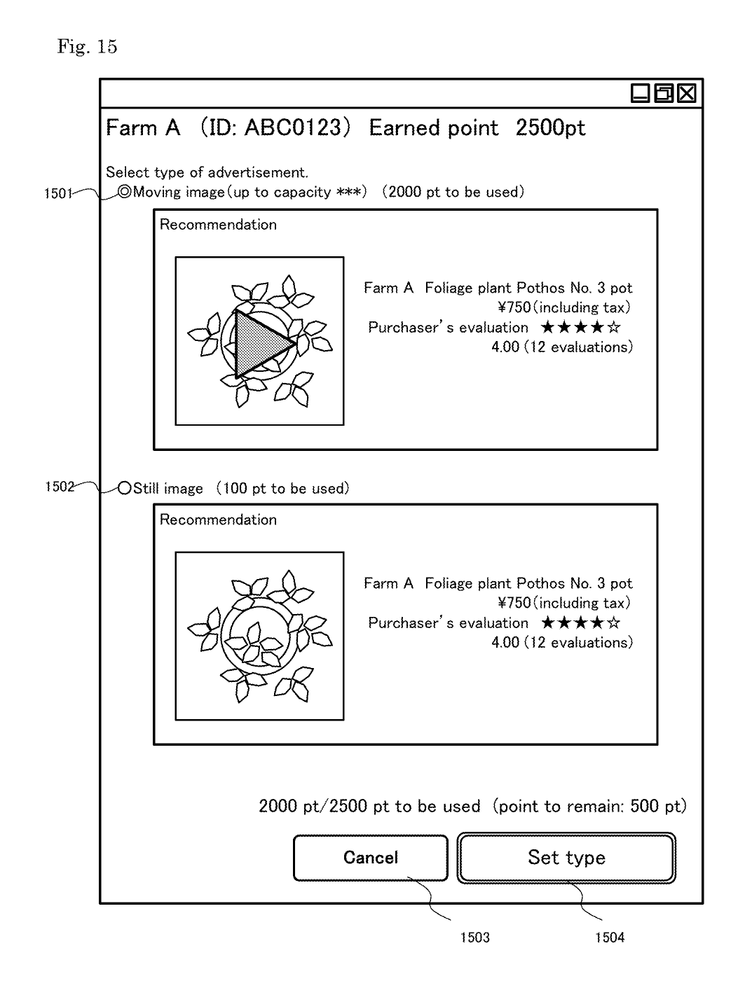

FIG. 15 shows one example of the screen to select the type of an advertisement to be displayed on the seller's terminal 300. In this figure, the farm A whose ID is ABC0123 currently has 2500 points, and the radio buttons 1501 and 1502 are provided to select the display type of an advertisement. The radio buttons 1501 and 1502 are user interfaces to select an advertisement type of an advertisement from a moving image and a still image, which consumes 2000 and 100 points from the earned points if the radio buttons 1501 and 1502 are selected, respectively. FIG. 15 shows that the radio button 1501 is selected. The seller sets the type of an advertisement to be displayed by pressing the set-type button 1504 after selecting the type of an advertisement on this screen. If selecting the cancellation button 1503, a seller can cancel the selection of the type of an advertisement. The remaining points may be displayed after the type of an advertisement is set. FIG. 15 shows an example to only select a moving image or a still image. However, an option to select a capacity of the moving image may be included. In addition, if there is an option that cannot be selected because the present earned points are not enough, the option and its radio button may gray out or may not be displayed.

FIGS. 13, 14, and 15 show one example of the screen to independently select the display size, the location, and the type of an advertisement, respectively. However, the screen may be a user interface to show a list combining the display size, the location, and the type of an advertisement as options. Moreover, the user interface may be a screen flow to sequentially select the display size, the location, and the type. In this case, the selection sequence of the display size, the location, and the type can be freely set. Moreover, the earned points to be consumed by selecting each item can be arbitrarily set and appropriately changed in the system for supporting sale.

The server 200 creates an advertisement to be placed on the system for supporting sale based on the data such as the display size, the location, the type, etc., of an advertisement that are received from the seller's terminal 300 and transmits advertising data to the purchaser's terminal 100 from which the system for supporting sale is viewed (step S08).

The purchaser's terminal 100 displays the advertising data received from the server 200 (step S09). The purchaser's terminal 100 is not always the same as the purchaser's terminal 100 of a purchaser who purchased an article in the step S03 but a terminal of a purchaser who uses the system for supporting sale.

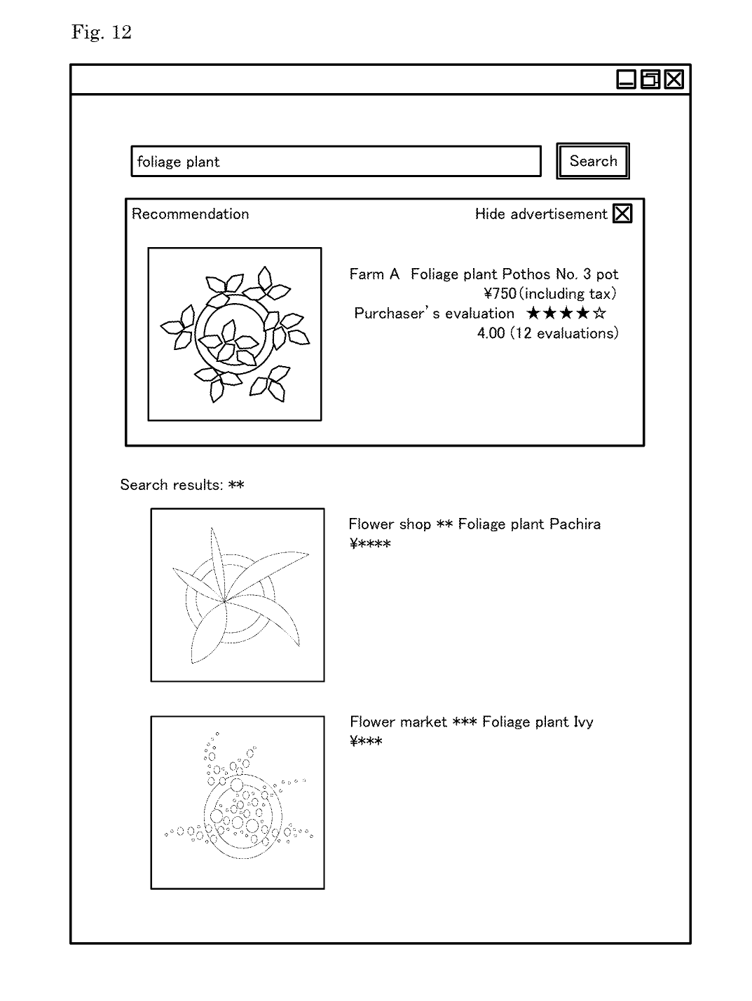

FIG. 12 shows one example of the advertisement display on the purchaser's terminal 100. Specifically, FIG. 12 shows that an advertisement is displayed as “Recommendation” when the user retrieves the key word “Foliage plant,” for example. In FIG. 12, the display size, the display location, and the type of the advertisement are selected to large, upper, and a still image, respectively, for example.

### Functions

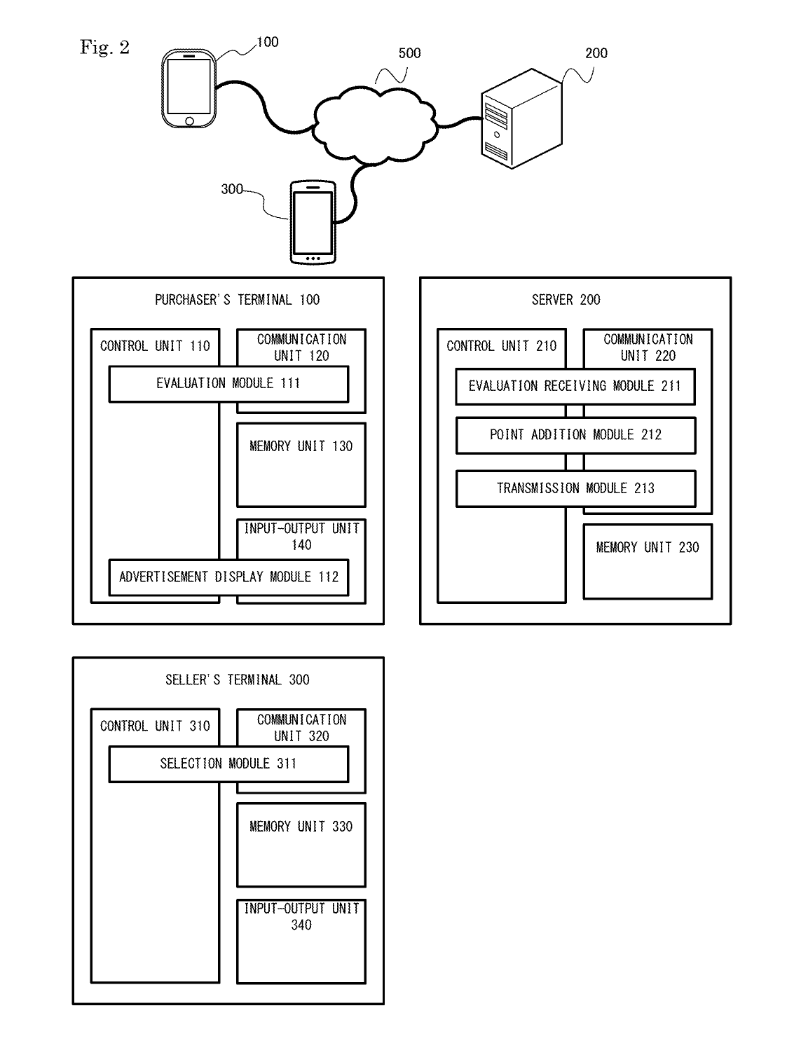

FIG. 2 shows a functional block diagram of the purchaser's terminal 100, the server 200, and the seller's terminal 300 to illustrate the relationship among the functions. The system for supporting sale includes a plurality of purchaser's terminals 100, the server 200, a plurality of seller's terminals 300, and a communication network 500 such as the Internet. The purchaser's terminal 100 and the seller's terminal 300 may communicate with the server 200 through a dedicated network, etc. There is no problem on the structure even if the purchaser's terminal 100 does not directly communicate with the seller's terminal 300.

The purchaser's terminal 100 includes a control unit 110, a communication unit 120, a memory unit 130, and an input-output unit 140. The control unit 110 runs an evaluation module 111 in cooperation with the communication unit 120. The control unit 110 also runs an advertisement display module 112 in cooperation with the input-output unit 140. The server 200 includes a control unit 210, a communication unit 220, and a memory unit 230.

The control unit 210 runs an evaluation receiving module 211, a point addition module 212, and a transmission module 213 in cooperation with the communication unit 220. The seller's terminal 300 includes a control unit 310, a communication unit 320, a memory unit 330, and an input-output unit 340. The control unit 310 runs a selection module 311 in cooperation with the communication unit 320.

The purchaser's terminal 100 may be a general information terminal capable of allowing a user to browse web pages and executing various applications. The terminal 100 is an information device or an electrical appliance with the functions to be described later. For example, the terminal 100 may be a general information appliance such as a mobile phone, a smart phone, a tablet PC, a notebook, or a wearable device, a complex printer, a television, and a network device such as a router or a gateway. The terminal 100 may also be a white good such as a refrigerator or a washing machine. The terminal 100 may also be an electrical appliance such as a telephone, a netbook terminal, a slate terminal, an electronic book terminal, an electronic dictionary terminal, a portable music player, and a portable content player and recorder. The smart phone shown as the purchaser's terminal 100 in attached drawings is just one example.

In the purchaser's terminal 100, the control unit 110 includes a central processing unit (hereinafter referred to as “CPU”), a random access memory (hereinafter referred to as “RAM”), and a read only memory (hereinafter referred to as “ROM”).

The communication unit 120 includes a Wireless Fidelity (Wi-Fi®) enabled device complying with, for example, IEEE 802.11, or a wireless device complying with the IMT-2000 standard such as the third generation mobile communication system. The communication unit may include a wired device for LAN connection.

In the purchaser's terminal 100, the control unit 110 reads a predetermined program to run an evaluation module 111 in cooperation with the communication unit 120.

The purchaser's terminal 100 also includes a storage unit as the memory unit 130 such as a hard disk or a semiconductor memory to store data. The memory unit 130 can store necessary information such as temporary data to purchase an article and to display an advertisement.

The input-output unit 140 has functions to perform operation and display required to purchase an article and to display an advertisement. The input-output unit 140 may include a liquid crystal display with a touch panel function, a keyboard, a mouse, a pen tablet, a hardware button on the device, and a microphone to perform voice recognition as examples of the input unit. The input-output unit 140 may take various forms such as a liquid crystal display, a PC display, and a projector as examples of the output unit. The input-output unit 140 may have a voice output function such as a speaker. The features of the present invention are not limited in particular by an input-output method.

In the purchaser's terminal 100, the control unit 110 reads a predetermined program to run an advertisement display module 112 in cooperation with the output unit of the input-output unit 140.

The server 200 may be a general server provided with the functions to be described later.

The server 200 includes a control unit 210 provided with CPU, RAM, ROM, etc.

The communication unit 220 includes a Wi-Fi® enabled device complying with, for example, IEEE 802.11, or a wireless device complying with the IMT-2000 standard such as the third generation mobile communication system. The communication unit may include a wired device for LAN connection.

In the server 200, the control unit 210 reads a predetermined program to run an evaluation receiving module 211, a point addition module 212, and a transmission module 213 in cooperation with the communication unit 220.

The server 200 also includes a storage unit as the memory unit 230 such as a hard disk or a semiconductor memory to store data. The memory unit 230 can store information necessary for the system for supporting sale, such as a purchaser, a seller, article information, and a point.

The seller's terminal 300 may be a general information terminal capable of allowing a user to browse web pages and executing various applications. The terminal 300 is an information device or an electrical appliance with the functions to be described later. For example, the terminal 300 may be a general information appliance such as a mobile phone, a smart phone, a tablet PC, a notebook, or a wearable device, a complex printer, a television, and a network device such as a router or a gateway. The terminal 300 may also be a white good such as a refrigerator or a washing machine. The terminal 300 may also be an electrical appliance such as a telephone, a netbook terminal, a slate terminal, an electronic book terminal, an electronic dictionary terminal, a portable music player, and a portable content player and recorder. The smart phone shown as the seller's terminal 300 in attached drawings is just one example.

The seller's terminal 300 includes a control unit 310 provided with CPU, RAM, ROM, etc.

The communication unit 320 includes a Wi-Fi® enabled device complying with, for example, IEEE 802.11, or a wireless device complying with the IMT-2000 standard such as the third generation mobile communication system. The communication unit may include a wired device for LAN connection.

In the seller's terminal 300, the control unit 310 reads a predetermined program to run a selection module 311 in cooperation with the communication unit 320.

The seller's terminal 300 also includes a storage unit as the memory unit 330 such as a hard disk or a semiconductor memory to store data. The memory unit 330 can store necessary information such as temporary data necessary for article information and advertising data selection.

The input-output unit 340 has functions to perform operation and display necessary for article information and advertising data selection. The input-output unit 340 may include a liquid crystal display with a touch panel function, a keyboard, a mouse, a pen tablet, a hardware button on the device, and a microphone to perform voice recognition as examples of the input unit. The input-output unit 340 may take various forms such as a liquid crystal display, a PC display, and a projector as examples of the output unit. The input-output unit 340 may have a voice output function such as a speaker. The features of the present invention are not limited in particular by an input-output method.

### Advertisement Display Process

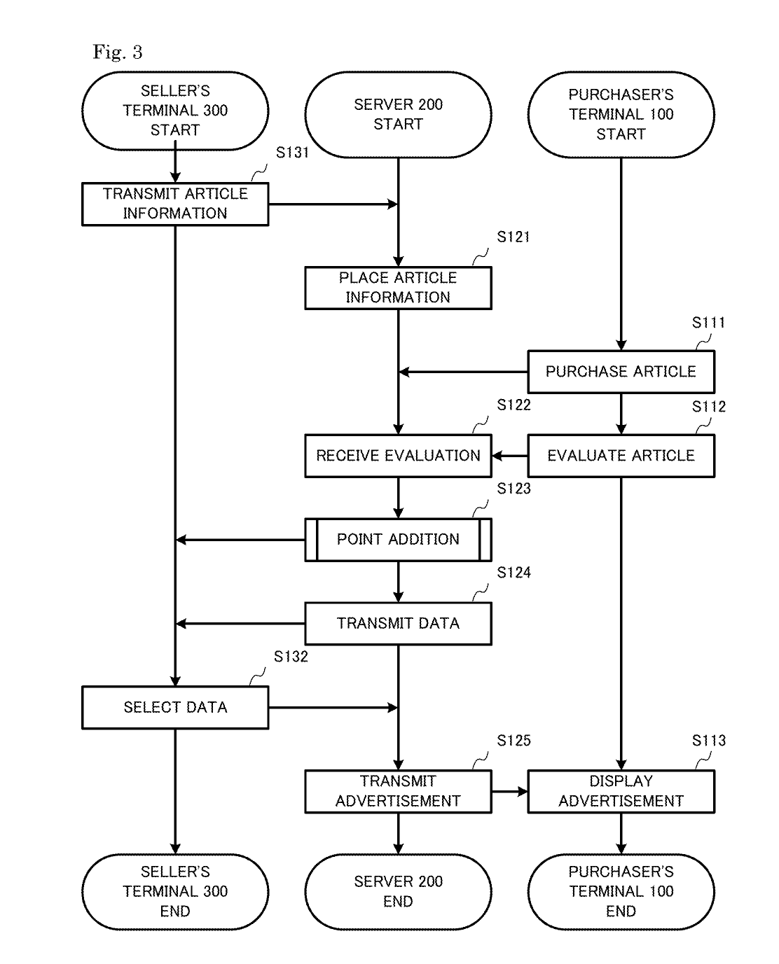

FIG. 3 shows a flow chart of the point addition and the advertisement display performed by the purchaser's terminal 100, the server 200, and the seller's terminal 300 in the system for supporting sale. The tasks executed by the modules of the above-mentioned devices are explained below together with this process. As described above, the respective numbers of the purchaser's terminal 100 and the seller's terminal 300 do not have to be one. The purchaser's terminal 100 and the seller's terminal 300 should communicate with the server 200 through a network, etc. There is no problem even if the purchaser's terminal 100 may not directly communicate with the seller's terminal 300.

First, the seller's terminal 300 first transmits article information on an article to be sold to the server 200 (step S131). The article information includes the brand name, price, seller, stock quantity of an article to be sold, and the seller's ID.

FIG. 7 shows one example of the article information transmitted from the seller's terminal 300 to the server 200. The article information includes a seller's ID in addition to a brand name, a price, and a stock quantity. Providing a unique ID to a seller, the system can recognizes the seller as the same seller even if the seller uses a plurality of seller's terminals such as a seller's terminal 300a, for example, a desktop personal computer and a seller's terminal 300b, for example, a smart phone. The image information, the details, etc., of an article may be transmitted together with the article information.

Then, the server 200 receives the article information from the seller's terminal 300 and places article information (step S121). The article informational is placed on a website of the system for supporting sale, an online shopping site, etc., on a network, which a user can view on a purchaser's terminal 100.

FIG. 8 shows one example of the article sales page displayed on the purchaser's terminal 100. Information necessary for a purchaser that includes the brand name, the price, and the seller of the sales article is displayed. The image information, the product details, the stock status of an article, the evaluation of an article from other purchasers, etc., may also be displayed.

The purchaser's terminal 100 purchases an article based on the displayed article information (step S111). For example, the user selects a purchase quantity from the combo box 801 and selects the add-to-cart button 802 with an article, on the article sales page shown in FIG. 8. Then, the user presses the proceed-to-checkout button 803 to perform necessary checkout procedure, for example, to input a delivery address, a payment option, etc. The article checkout procedure is not limited to the scope of the present invention. Any methods used in a typical online shopping can be applied.

After purchasing an article, the user evaluates the article purchased from the evaluation module 111 of the purchaser's terminal 100 (step S112). The evaluation represents the satisfaction of the purchased article or with the seller in a number. The number of evaluation item does not have to be one and may be two or more. When the number of the evaluation items is two or more, the respective numerical values, the average score, or the total point of all the evaluation items may be transmitted to the server 200.

FIG. 9 shows one example of the article evaluation page displayed on the purchaser's terminal 100. When inputting the evaluation of an article, a purchaser can evaluate an article by selecting only the number of marks corresponding to the evaluation value in the evaluation graph 901 or by selecting a numerical value corresponding to the evaluation by the combo box 902. When inputting the evaluation of a seller, a purchaser selects only the number of marks corresponding to the evaluation value in the evaluation graph 903 or selects a numerical value corresponding to the evaluation by the combo box 904 in the same way. The example of FIG. 9 shows a screen to which a purchaser inputs only the numerical value of evaluation. However, the screen has a structure in which a purchaser can enter evaluation in text. The evaluation is transmitted to the server 200 by selecting the transmission button 906. The transmission of evaluation can be canceled by selecting the cancellation button 905.

The server 200 receives the evaluation of the article purchased from the purchaser's terminal 100 by using the evaluation receiving module 211 (step S122).

The server 200 provides a point to the seller's ID of the article based on the received evaluation by using the point addition module 212 (step S123). The details of the point addition method are described later.

The server 200 transmits data required to place an advertisement on the system for supporting sale to the seller's terminal 300 by using the transmission module 213 (step S124). This data is information required to select the size, the location, the type, etc., of the advertisement that a seller wishes to place. The server 200 also transmits the earned points of a seller's ID.

The seller's terminal 300 selects data to place an advertisement on the system for supporting sale based on the data received from the server 200 and transmits the selection result to the server 200, by using the selection module 311 (step S132).

FIG. 13 shows one example of the screen to select the display size of an advertisement to be displayed on the seller's terminal 300. In this figure, the farm A whose ID is ABC0123 currently has 500 points, and the radio buttons 1301 to 1303 are provided to select the display size of an advertisement. The radio buttons 1301, 1302, and 1303 are user interfaces to select a size of an advertisement from the large, medium, and small, which consumes 300, 200, and 100 points from the earned points, respectively. The radio buttons are to select only one from a plurality of choices. FIG. 13 shows that the radio button 1302 is selected. The seller sets the size of an advertisement to be displayed by pressing the set-display-size button 1305 after selecting the display size of an advertisement on this screen. If selecting the cancellation button 1304, a seller can cancel the selection of the display size of an advertisement. The remaining points may be displayed after the display size of an advertisement is set. In addition, if there is an option that cannot be selected because the present earned points are not enough, the option and its radio button may gray out or may not be displayed.

FIG. 14 shows one example of the screen to select the display location of an advertisement to be displayed on the seller's terminal 300. In this figure, the farm A whose ID is ABC0123 currently has 400 points, and the radio buttons 1401 to 1403 are provided to select the display location of an advertisement. The radio buttons 1401, 1402, and 1403 are user interfaces to select a location an advertisement from the upper, right, and lower, which consumes 250, 150, and 50 points from the earned points, respectively. FIG. 14 shows that the radio button 1401 is selected. The seller sets the display location of an advertisement to be displayed by pressing the set-display-location button 1405 after selecting the display location of an advertisement on this screen. If selecting the cancellation button 1404, a seller can cancel the selection of the display location of an advertisement. The remaining points may be displayed after the display location of an advertisement is set. In addition, if there is an option that cannot be selected because the present earned points are not enough, the option and its radio button may gray out or may not be displayed.

FIG. 15 shows one example of the screen to select the type of an advertisement to be displayed on the seller's terminal 300. In this figure, the farm A whose ID is ABC0123 currently has 2500 points, and the radio buttons 1501 and 1502 are provided to select the display type of an advertisement. The radio buttons 1501 and 1502 are user interfaces to select an advertisement type of an advertisement from a moving image and a still image, which consumes 2000 and 100 points from the earned points if the radio buttons 1501 and 1502 are selected, respectively. FIG. 15 shows that the radio button 1501 is selected. The seller sets the type of an advertisement to be displayed by pressing the set-type button 1504 after selecting the type of an advertisement on this screen. If selecting the cancellation button 1503, a seller can cancel the selection of the type of an advertisement. The remaining points may be displayed after the type of an advertisement is set. FIG. 15 shows an example to only select a moving image or a still image. However, an option to select a capacity of the moving image may be included. In addition, if there is an option that cannot be selected because the present earned points are not enough, the option and its radio button may gray out or may not be displayed.

FIGS. 13, 14, and 15 show one example of the screen to independently select the display size, the location, and the type of an advertisement, respectively. However, the screen may be a user interface to show a list combining the display size, the location, and the type of an advertisement as options. Moreover, the user interface may be a screen flow to sequentially select the display size, the location, and the type. In this case, the selection sequence of the display size, the location, and the type can be freely set. Moreover, the earned point to be consumed by selecting each item can be arbitrarily set and appropriately changed in the system for supporting sale.

The server 200 creates an advertisement to be placed on the system for supporting sale based on the data such as the display size, the location, the type, etc., of an advertisement that are received from the seller's terminal 300 and transmits advertising data to the purchaser's terminal 100 from which the system for supporting sale is viewed (step S125).

The purchaser's terminal 100 displays the advertising data received from the server 200 by using the advertisement display module 112 (step S113). The purchaser's terminal 100 is conveniently described as the same as added by the purchaser's terminal 100 of a purchaser who purchased an article in the step S111, but not always the same. The purchaser's terminal 100 displaying an advertisement is any terminal of a purchaser who uses the system for supporting sale.

FIG. 12 shows one example of the advertisement display on the purchaser's terminal 100. Specifically, FIG. 12 shows that an advertisement is displayed as “Recommendation” when the user retrieves the key word “Foliage plant,” for example. In FIG. 12, the display size, the display location, and the type of the advertisement are selected to large, upper, and a still image, respectively, for example.

In this example, the display size, the display location, and the type of an advertisement are selected. However, the display frequency, the period, the display time zone, the article to be advertised may also be selected. Moreover, the user interfaces of FIGS. 13, 14, and 15 may lead a seller to make a selection to obtain higher advertising effectiveness, for example, by increasing the display size or prominently placing the advertisement if points provided to the seller's ID are large.

In addition, the evaluation average by a purchaser may be added to the condition to display an advertisement. In the example of FIG. 10, assuming that the advertisement of a seller with an evaluation average of 3.20 or more can be displayed, the farm A and the shop B have an evaluation average of 4.00 and 3.29, respectively, to display their advertisements. However, the market C has an evaluation average of 3.00 not to display its advertisement. If another purchaser of the shop B provides an evaluation score of 2, the evaluation average of the shop B becomes 3.13 not to display the previously displayed advertisement.

### Point Addition Process

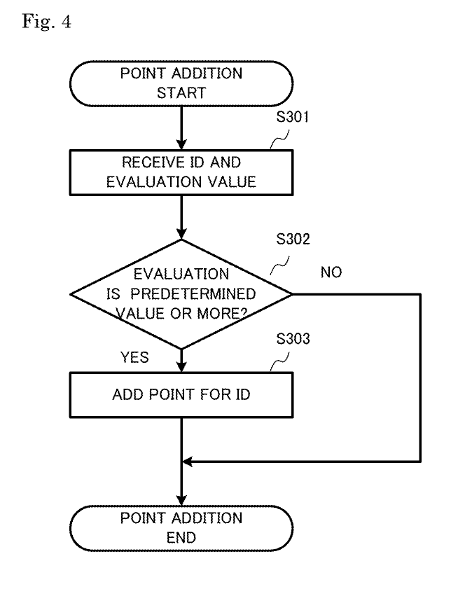

FIG. 4 shows a flow chart of the point addition by the server 200 based on the evaluation by the purchaser's terminal 100.

The server 200 receives the ID and the evaluation value of a seller from a purchaser's terminal 100 (step S301). The evaluation value represents the satisfaction of the purchased article or with the seller in a number as described above.

Then, the server 200 judges whether or not the evaluation value is a predetermined value set in the system for supporting sale or more (step S302).

If the evaluation value is a predetermined value or more, the server 200 adds a point corresponding to the evaluation value for the seller's ID (step S303). If the evaluation value is less than a predetermined value, the server 200 adds no points and ends the process.

FIG. 10 is one example of the data for each seller that include an evaluation from a purchaser and a point added based on the evaluation. In the example of FIG. 10, the predetermined value is 3. If the evaluation is 5, 4, and 3, 20, 10, and 5 points are added, respectively. However, if the evaluation is less than the predetermined value, 3, no points are added. As the result, the farm A, the shop B, and the market C earn 125, 45, and 20 points from 12, 7, and 4 evaluations, respectively. The number of points to be added based on each evaluation value can be arbitrarily set and appropriately changed in the system for supporting sale.

### Point Addition Process By Terminal For Supporting Sale

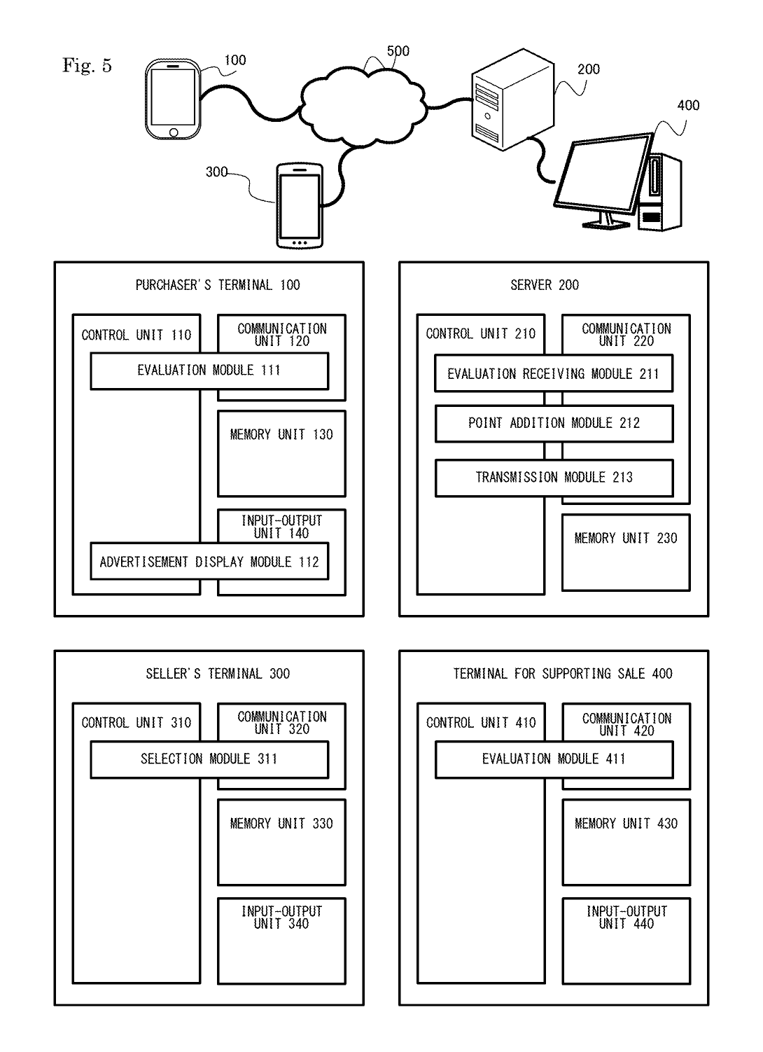

The points may be added by the terminal for supporting sale. FIG. 5 shows a functional block diagram of the purchaser's terminal 100, the server 200, the seller's terminal 300, and the terminal for supporting sale 400 to illustrate the relationship among the functions. FIG. 5 shows the functions of the terminal for supporting sale 400 in addition to those shown in FIG. 2. The terminal for supporting sale 400 can be directly or communicatively connected with the server 200. The functions of the purchaser's terminal 100, the server 200, and the seller's terminal 300 are described above. Therefore, the explanation of the details is omitted.

The terminal for supporting sale 400 may be a general information terminal such as an information device or an electrical appliance that has the functions to be described later. For example, the terminal 400 may be a general information appliance such as a mobile phone, a smart phone, a tablet PC, a notebook, or a wearable device, a complex printer, a television, and a network device such as a router or a gateway. The terminal 400 may also be a white good such as a refrigerator or a washing machine. The terminal 400 may also be an electrical appliance such as a telephone, a netbook terminal, a slate terminal, an electronic book terminal, an electronic dictionary terminal, a portable music player, and a portable content player and recorder. The desktop personal computer provided with a display that is shown as the terminal for supporting sale 400 in attached drawings is just one example.

The terminal for supporting sale 400 includes a control unit 410 provided with CPU, RAM, ROM, etc.

The communication unit 420 has a function to communicate with the server 200 through direct, wired, or wireless connection.

In the terminal for supporting sale 400, the control unit 410 reads a predetermined program to run an evaluation module 411 in cooperation with the communication unit 420.

The terminal for supporting sale 400 also includes a storage unit as the memory unit 430 such as a hard disk or a semiconductor memory to store data. The memory unit 430 can store necessary information such as temporary data for seller information and evaluation.

The input-output unit 440 has functions to perform operation and display necessary for evaluation. The input-output unit 440 may include a liquid crystal display with a touch panel function, a keyboard, a mouse, a pen tablet, a hardware button on the device, and a microphone to perform voice recognition as examples of the input unit. The input-output unit 440 may take various forms such as a liquid crystal display, a PC display, and a projector as examples of the output unit. The input-output unit 440 may have a voice output function such as a speaker. The features of the present invention are not limited in particular by an input-output method.

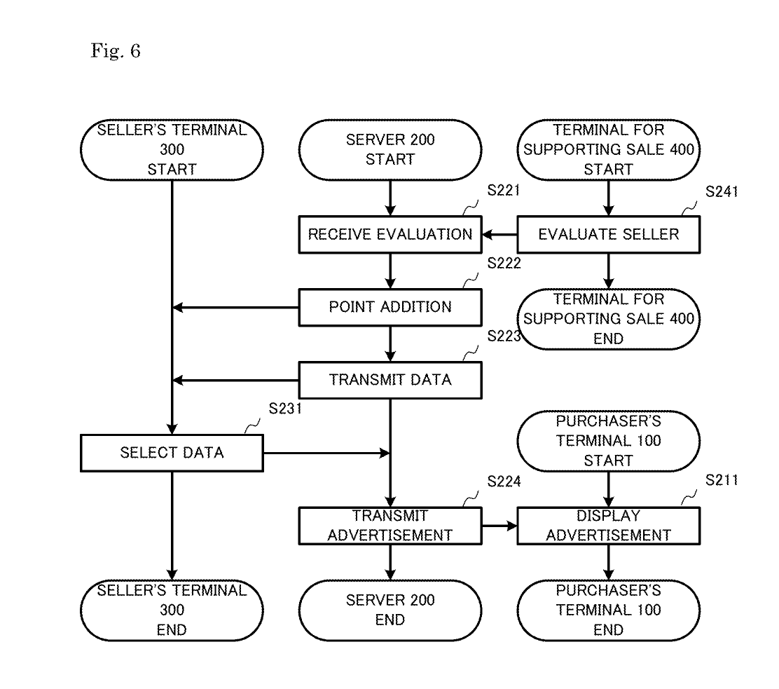

FIG. 6 shows a flow chart of the point addition and the advertisement display performed by the purchaser's terminal 100, the server 200, the seller's terminal 300, and the terminal for supporting sale 400.

The terminal for supporting sale 400 evaluates a seller by using the evaluation module 411 (step S241). The terminal for supporting sale 400 may evaluate a seller based on the total point and the average point of evaluation of a seller or based on the frequency of use of the system for supporting sale. In this example, the purchaser's terminal 100 evaluates a seller on zero-to-five scale. However, the terminal for supporting sale 400 does not have to evaluate a seller on 6-point scale.

The server 200 receives the evaluation of a seller from the terminal for supporting sale 400 by using the evaluation receiving module 211 (step S221).

The server 200 provides a point to the seller's ID based on the received evaluation result by using the point addition module 212 (step S222). In this example, a point is added for evaluation from the terminal for supporting sale 400 but does not have to be added in the same way as added by the purchaser's terminal 100. For example, 100 points may be added for the evaluation, 5, received by the terminal for supporting sale 400.

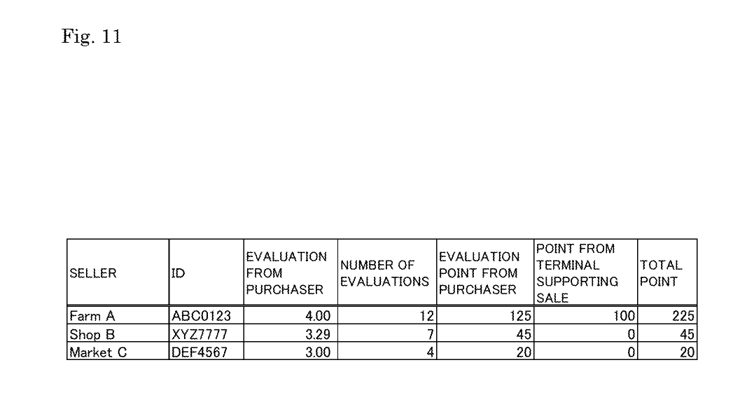

FIG. 11 shows one example of the data for each seller that include a point added based on the evaluation, a point added by a terminal for supporting sale, and a total point. This example shows that the farm A earns 125 points from the evaluation of purchasers and 100 points added by the terminal for supporting sale, and the total point comes to 225 points. This example also shows that the shop B earns 45 points from the evaluation of purchasers and 0 points added by the terminal for supporting sale, and the total point comes to 45 points. This example also shows that the market C earns 20 points from the evaluation of purchasers and 0 points added by the terminal for supporting sale, and the total point comes to 20 points.

The server 200 transmits data to place an advertisement on the system for supporting sale to the seller's terminal 300 by using the transmission module 213 (step S223). This data is information required to select the size, the location, the type, etc., of the advertisement that a seller wishes to display on the seller's terminal 300. The server 200 also transmits the earned points of a seller's ID.

The seller's terminal 300 selects data to place an advertisement on the system for supporting sale based on the data received from the server 200 and transmits the selection result to the server 200, by using the selection module 311 (step S231).

FIG. 13 shows one example of the screen to select the display size of an advertisement to be displayed on the seller's terminal 300. FIG. 14 shows one example of the screen to select the display location of an advertisement to be displayed on the seller's terminal 300. FIG. 15 shows one example of the screen to select the type of an advertisement to be displayed on the seller's terminal 300. The details of these examples are as described above.

FIGS. 13, 14, and 15 show one example of the screen to independently select the display size, the location, and the type of an advertisement, respectively. However, the screen may be a user interface to show a list combining the display size, the location, and the type of an advertisement as options. Moreover, the user interface may be a screen flow to sequentially select the display size, the location, and the type. In this case, the selection sequence of the display size, the location, and the type can be freely set. Moreover, the earned point to be consumed by selecting each item can be arbitrarily set and appropriately changed in the system for supporting sale.

The server 200 creates an advertisement to be placed on the system for supporting sale based on the data such as the display size, the location, the type, etc., of an advertisement that are received from the seller's terminal 300 and transmits advertising data to the purchaser's terminal 100 from which the system for supporting sale is viewed (step S224).

The purchaser's terminal 100 displays the advertising data received from the server 200 by using the advertisement display module (step S211). The purchaser's terminal 100 displaying an advertisement is any terminal of a purchaser who uses the system for supporting sale.

FIG. 12 shows one example of the advertisement display on the purchaser's terminal 100. The details are as described above.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), DVD (e.g., DVD-ROM, DVD-RAM), or a compact memory. In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

100 Purchaser's terminal
200 Server
300 Seller's terminal
400 Terminal for supporting sale
500 Communication network

What is claimed is:

1. A system for supporting sale of an article, comprising:
an evaluation unit that evaluates a seller of the article;
a point addition unit that adds a point based on the evaluation; and
an advertisement display unit that displays an advertisement of the article on a purchaser's terminal by consuming the point.

2. The system according to claim 1, wherein the evaluation unit receives an evaluation from the purchaser's terminal, the user of which purchases the article.

3. The system according to claim 1, wherein the evaluation unit receives an evaluation from a terminal for supporting sale of the system.

4. The system according to claim 1, further comprising a selection unit that selects a display size of an advertisement of the article based on the consumed point.

5. The system according to claim 1, further comprising a selection unit that selects a display location of an advertisement of the article based on the consumed point.

6. The system according to claim 1, further comprising a selection unit that selects a type of an advertisement of the article based on the consumed point.

7. The system according to claim 1, further comprising a transmission unit that transmits data to select any one of a display size, a display location, and a type of an advertisement of the article based on the consumed point to a purchaser's terminal.

8. A method executed by a system for supporting sale of an article, comprising the steps of:
evaluating a seller of the article;
adding a point based on the evaluation; and
displaying the advertisement of the article on a purchaser's terminal by consuming the point.
